(19) United States
(12) Patent Application Publication
(10) Pub. No.: US 2006/0215859 A1
(43) Pub. Date: Sep. 28, 2006

(54) Sonic method and apparatus

(76) Inventor: Charles G. Morrow, New York, NY (US)

Correspondence Address: John P. Sinnott, 1007 N. Patterson Street, Valdosta, GA, 31601, US

(21) Appl. No.: 11/091,269

(22) Filed: Mar. 28, 2005

(51) Int. Cl. H04R 5/02

(52) U.S. Cl. 381/300; 381/307

(57) ABSTRACT

Full field sound and the perception of a moving sound source are combined by mounting an array of sound transducers. Some of the transducers are mounted above a listener's ear level and some of the transducers are mounted below the listener's ear level. The sounds generated by all of the transducers are oriented toward a common volume in which all of the generated sound intersects. A further sound transducer spaced from some of the other transducers also projects its generated sound into the common volume, thereby producing both a full field effect and the perception of a moving sound source.

### CROSS-REFERENCES TO RELATED APPLICATIONS

None

### STATEMENT REGARDING FEDERALLY SPONSORED RESEARCH OR DEVELOPMENT

None

### REFERENCE TO “SEQUENCE LISTING”

None

### BACKGROUND OF THE INVENTION

This invention relates to methods and apparatus for sound reproduction and more particularly to spatial arrays of sound transducers for creating an aural sensation that the sound source is moving relative to the listener, and the like.

Earlier efforts to create aural sensations that would exploit the potentials existing in the binaural nature of human hearing (the perception of sound with both cars) were not entirely satisfactory in their results. These efforts did lead to some stereoscopic aural effects in an attempt to produce a perception of a more natural sound. All of these techniques—many of them quite elaborate in both the arrangement of the loud speakers and in the supporting electrical circuits—nevertheless failed to replicate nature.

Illustrative of these efforts was a proposal to arrange eight loudspeakers in a non-square cuboid assembly, each of the loudspeakers being mounted in an individual corner of the assembly. An elaborate system of decoder, gain adjustment and amplitude matrix circuits processed system input signals into combination signals that were applied to respective loudspeakers.

This system still failed to provide a truly satisfactory binaural listener response. For example, these prior art systems were not able to stimulate adequately the sensation of a moving sound source. Thus, although the change in frequency as a moving sound source approached and then moved away from the listener, the Doppler Effect, could be projected through many of these systems, the systems still failed to create a perception of motion for the source of the sound relative to the listener.

As a general matter, it has not been possible to combine satisfactorily a system to establish a sound field that extends in all directions relative to the listener, an “ambisonic” system, with a system that generates a sound in which the source appeals to move relative to the listener, a “panned” system. With respect to those systems that generate a sound field that extends in all directions relative to the listener, there is a further difficulty. These systems for instance, are quite sensitive to listener movement, there being only one physical location within the system that provides best listening results. Consequently, listener movement and particularly head movement which is so fundamental to binaural sound stimulation, tends to degrade the perceived quality of the sound output.

As a result, there is a need for improved sound distribution methods and apparatus. More particularly, there is a need to produce binaural listener effects that more closely mimic nature and offer an entirely new set of artistic options for creating truly realistic sonic effect.

### BRIEF SUMMARY OF THE INVENTION

These and other needs are satisfied, to a great extent, through the practice of the invention.

A typical embodiment of the invention mounts eight sound transducers, each spaced from the other to form a parallelepiped array each of the transducers occupying a respective corner of the array in order to establish the parallelepiped spatial relationship. The transducers are oriented to project the sounds that they generate to a common place of intersection within the array, one set of four transducers being positioned above the listener's ear level and the other set of four transducers being positioned below the listener's ear level.

In accordance with a feature of the invention, a ninth sound transducer is mounted in a plane of the parallelepiped. This ninth transducer also projects its sound output into the volume of the parallelepiped that corresponds to the common place of intersection for the sound outputs from the other eight transducers.

This illustrative embodiment of the invention not only produces a sound field that extends in all directions, but it also satisfies the need for a system that will produce a satisfactory perception that the source of the sound is moving relative to the listener. Further in that respect, the system is generally insensitive to listener movement, the sound field being satisfactory within the parallelepiped established by the eight transducers listener head movement notwithstanding.

The structure and method that characterize the invention also satisfies the need for a new approach to a sound reproduction technology that offers fresh artistic options for creating improved listener perceptions.

For instance, several parallelepiped arrays can be assembled, side by side, to produce even further impressive sonic effects. In a large gallery displaying a number of exhibits, this side-by-side arrangement of the transducer arrays can permit individual arrays to be activated without interfering with the sounds being generated in adjoining arrays

The ninth transducer, moreover, need not be so limited. A tenth transducer or even more transducers can be mounted on the same or other parallelepiped planes, or even within the volume of the parallelepiped to produce further unusual sound perceptions for the listener.

Nor does the spacing among the sound transducers necessarily have to be limited to a parallelepiped configuration. The principles of the invention can be applied to any geometric shape or structure, e.g. a geodesic dome.

Thus, there is provided in accordance with the invention an improved method and apparatus for sound reproduction as described below in more complete detail with respect to preferred embodiments of the invention. The scope of the invention, however, is limited only through the claims appended hereto.

### BRIEF DESCRIPTION OF THE DRAWING

FIG. 1 is an isometric view of a typical embodiment of the invention;

FIG. 2 is a top elevation of the embodiment of the invention shown in the plane A-A of FIG. 1;

FIG. 3 is a front elevation of the embodiment of the invention shown in FIG. 1;

FIG. 4 is a perspective view of a further embodiment of the invention; and

FIG. 5 is a perspective view of another embodiment of the invention.

### DETAILED DESCRIPTION OF PREFERRED EMBODIMENTS OF THE INVENTION

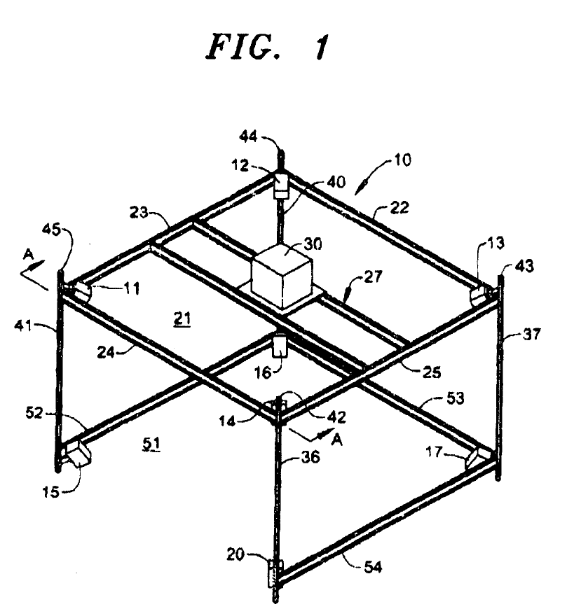

A specific embodiment of the invention is shown in FIG. 1. As illustrated, an array 10 of eight transducers 11, 12, 13, 14, 15, 16, 17 and 20 are spaced from each other to form a parallelepiped or, as shown in this embodiment of the invention, a cuboid 21. For the purpose of the embodiment Genelec 1029A sound transducers have been found to be satisfactory. Note in this respect that four of the sound transducers 11-14 are mounted in the manner subsequently described above the level of the listener's cars (not shown) and the sound transducers 15-17 and 20 are, mutatis mutandis, mounted below the listener's ear.

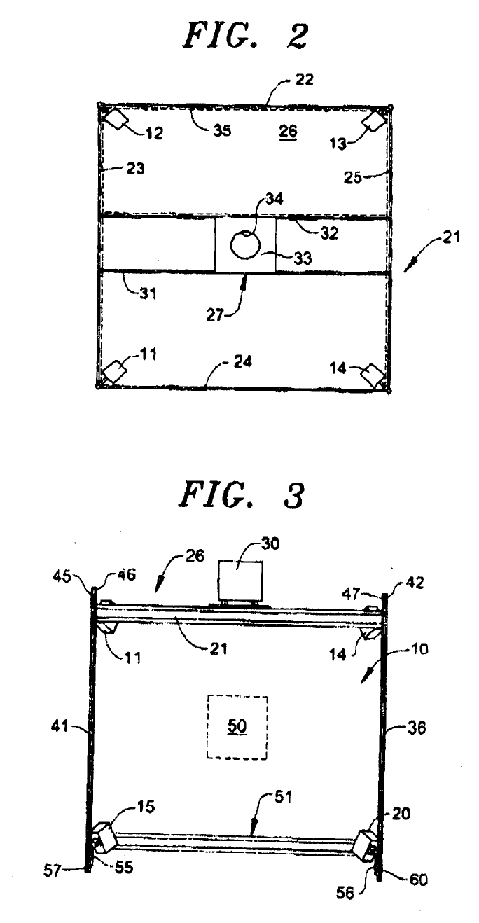

To provide the separation among the transducers the array 10 has a rectangular framework of structural members. Members, or cross beams 22, 23, 24 and 25 are joined together at their respective ends to form corners of a square, planar surface 26 (FIG. 2) for the cuboid 21. Suitable cross beams for this purpose are identified in the Octanorm Systems Catalog through the reference numeral Z534 and each of these cross beams are 9.6′ (2930 mm) in length to form the square surface 26. The sound transducers 11 through 14 are each mounted in a respective one of the corners of the square surface formed by the intersections of two associated cross beams. Thus, the sound transducer 11 is mounted in the corner formed by the cross beams 23, 24; the sound transducer 12 is mounted at the corner formed by the cross beams 22, 23; the sound transducer 13 is mounted at the intersection of the cross beams 22, 25; and the sound transducer 14 is mounted in the corner formed by the cross beams 24, 25.

In accordance with a feature of the invention a support structure 27 for a “subwoofer” ninth sound transducer 30 (FIG. 1) typically having a sonic output frequency range of 31 Hz to 130 Hz (cycles/second) is assembled to mount the sound transducer 30 in the middle of the square surface 26 and to orient the sound output from the sound transducer 30 inwardly toward the center of the cuboid 21. It has been found, moreover, that a Tannoy PSL10 active subwoofer is suitable for application in this embodiment of the invention. Turning once more to FIG. 2, it can be seen that the support structure 27 includes a pair of support members 31, 32 that span the distance between the parallel cross beams 23, 25. For the support members 31, 32 Octanorm Systems Catalog number S969 members have been found satisfactory for this use in connection with the invention.

The support member 31 is joined to the cross beams 23, 25 it a distance of 3.8′ (1160 mm) from the parallel cross beam 24. The support member 32 is similarly spaced 3.8′ (1160 mm) from the parallel cross beam 22 to establish a separation of 2′ (610 mm) between the support members 31, 32. A mounting support 33 formed preferably from a plywood sheet about ¾″ (20 mm) in thickness and having 2′ by 2′ (610 mm by 610 mm) sides in length is secured to the midsection of the support members 31, 32. A hole 34, formed in the central portion of the mounting support 33 enables the ninth sound transducer 30 (FIG. 1) to project its sound output into the central volume of the cuboid 21.

To conceal the signal conductors or wires associated with the sound transducers 11 through 17, 20 and 30 (FIG. 1) in order to provide a professionally finished structure and as best shown in FIG. 2, lengths of wireway snaps 35 are lodged in the cross beams 22, 23 and 25 and the support member 32, not only to conceal the signal conductors, but also to prevent these conductors from being accidentally disconnected from their associated sound transducers us a consequence of their otherwise exposed condition. The Octanorm Systems Catalog wireway snaps identified by the number E640, moreover, are suitable for this purpose.

As best illustrated in FIGS. 1 and 3, the structure for the square surface 26 is supported by four perpendicular beams 36, 37, 40 and 41. The beams 36, 37, 40 and 41 perpendicularly intersect respective corners formed by the junctions of the cross beams 24, 25; 25, 22; 22, 23; and 23, 24, Octanorm part number S100 has been found satisfactory for use as the perpendicular beams 36, 37, 40 and 41. Each of the perpendicular beams 36, 37, 40 and 41, in the embodiment of the invention shown in FIG. 3, has an overall length 9.5′ (2900 mm). This length enables short stubs 42, 43, 44 and 45 to protrude slightly beyond the square surface 26 formed by the cross beams 22, 23, 24 and 25, respectively, for distances, each of 6¾″ (170 mm).

Connected to each of the stubs 42, 43, 44 and 45, and only shown in FIG. 3, is a respective bracket of which only the brackets 46, 47 are illustrated for mounting the sound transducers 11, 14 to the perpendicular beams 41, 36. As mounted, the axes of the sound transducers 11, 12, 13 and 14 (FIG. 2) bisect the respective angles formed at the corresponding intersecting corners of the cross beams 22 through 25. In this way the sound outputs from each of the sound transduces 11 through 17 and 20 are oriented in the plane formed by the square surface 26 toward the center of the hole 34 (FIG. 2) in the middle of the mounting support 33 for the ninth sound transducer 30 (FIG. 3). For this purpose Octanorm Systems speaker brackets in the Omnimount 20.5 Series have been found suitable.

As best illustrated in FIGS. 2 and 3, with respect to the brackets 46, 47, these brackets also enable the supported sound transducers 11, 14 to pivot in a plane established by the square surface 21 and a perpendicular plane established by the center of the hole 34 and the axes of the associated perpendicular beams 36, 37, 40 and 41.

As a result, the sound transducers each are angled toward a centrally disposed volume, or a common place of intersection, 50 within the cuboid 21 in which the sound outputs from each of the four sound transducers 11 through 14, intersect not only with each other, but also with the inwardly disposed sound output from the ninth sound transducer 30.

A further square, planar surface 51 (FIG. 1), spaced from and parallel with the square surface 26 is formed through the perpendicular intersections of further cross seams 52, 53, 54. The Octanorm Systems number 2534 structural elements have been found quite satisfactory for use as the further cross bears 52, 53 and 54. At the corners formed by the intersections of the ends of the beams 52, 53 and 53, 54, the sound transducers 16, 17 are mounted on brackets 55, 56 (only two of these brackets are shown in FIG. 3 of the drawing). This mounting is essentially the same as that described above in connection with the brackets 46, 47 and, therefore, provide the same freedom of movement for the sound transducers 15 to 17 and 20 that the brackets 46, 47 to impart to the respective associated sound transducers 11 and 14 (FIG. 1). As a result, the sound transducers 15 through 17 and 20 also are oriented toward the common intersection 50 within the array 10.

As further illustrated in FIG. 3, each of the four perpendicular beams, of which only the beams 36 and 41 are shown in FIG. 3, have further stubs 57, 60 that protrude beyond the further square surface 51 by about 9″ (230 mm). The brackets 55, 60 are lodged in the respective stubs 57, 60.

It should also be noted that there is no cross beam a join the free ends of the cross beams 52 and 54 (FIG. 1) thereby forming a rectangular “U” shape for the cross beams 52 through 54 that define the further square surface 51. In this way, ease of access is provided by one or more listeners to the sounds concentrated at the common intersection 50.

In operation, the sound transducers 11 through 17, 20 and 30 are suitably energized. In keeping with a salient feature of the invention, the sound transducers can be energized through any suitable signal means, of which digital, analog, light pulses and the like are typical.

When suitably energized, the sound outputs from the nine sound transducers in the array 10 produce for the listener within the array 10 a significantly improved auditory perception. For example, for a listener within the array 10 the sound field seems to extend in all directions and the source of the sound seems to be moving relative to the listener, when appropriate. Illustratively, the movement of a flock of birds flying toward and then away from the listener is actually perceived as such. The listener's movement, however, does not interfere with this binaural response to the sound field. Should the listener, for example, indulge in head motion, the motion will not spoil or significantly diminish the aural stimulation provided by the invention.

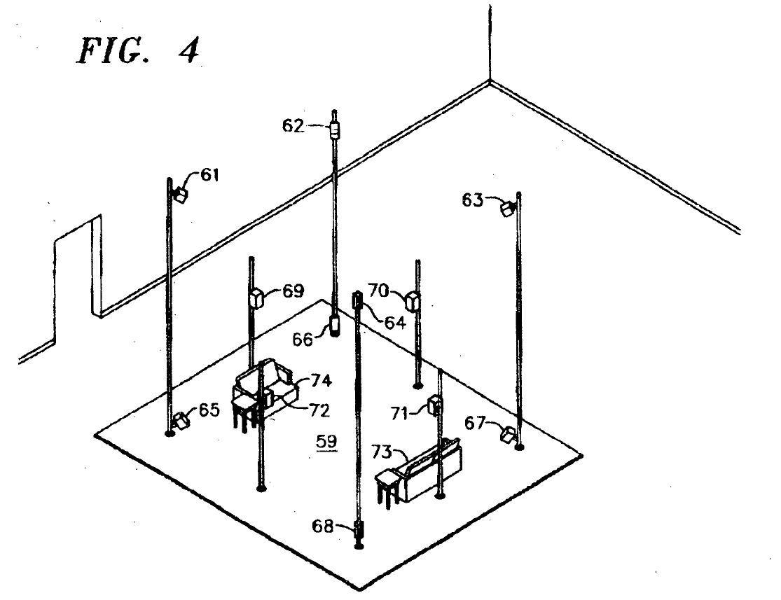

A further embodiment of the invention is illustrated in FIG. 4. As shown in FIG. 4, an array 59 of twelve sound transducers 61 through 72 mounted on poles are so spaced from each other that the group of sound transducers 61 through 64 are above the listeners' ear level; the sound transducers in the group 65 through 68 are positioned below the listeners' ear level and each of the remaining four sound transducers 69 through 72 are mounted in the respective centers of the surfaces formed by adjoining sets of the above-and-below ear level sound transducers 61 through 64 and 65 through 68. Thus:

| Sound Transducer | Adjoining Transducer Surfaces. |
|---|---|
| 69 | 61/62/66/65 |
| 70 | 62/63/67/66 |
| 71 | 63/64/68/67 |
| 72 | 64/61/65/68 |

It should be further noted in accordance with an additional characteristic of the invention that the parallelepiped nature of the array is more rectangular than cuboid. Thus, the liner separation distances between the sound transducers 61 and 64 and the companion below-ear level sound transducers 65 and 68 are considerably greater than the corresponding separation distance between the sound transducers 61 and 62 and their companion below-ear sound transducer 65 and 66.

The sound transducers 61 through 72 each are respectively oriented to intersect at a common volume within the array 59 to produce essentially the same unusual listener perception as those described with respect to the embodiment of the invention shown in FIGS. 1 through 3. Similarly, the method and apparatus described in connection with the alignment of the sound transducers shown in FIGS. 1 through 3 is largely, equivalent to that needed to align the sound transducers 61 through 72, as shown in FIG. 4.

Note also the positions of furniture 73, 74 within the array 59. The furniture 73, 74 is not located at a common intersection volume within the array 59 but to either side of that volume. Clearly, the sound perception of the listener, or listeners, is complete through this off-center arrangement. As such, the array 59 in FIG. 4 a provides a significant improvement over the limitations that have characterized earlier full-field sound systems.

FIG. 3 illustrates a further embodiment of the invention. A generally rectangular gallery 80 having dimensions of about 120′ in length by 26½′ in width and 26½′ in height has a number of visual displays 81 mounted on walls 82, 83. Each of the displays 81 has an individually associated motion activated speaker 84. The speakers 84, mounted on the walls 82, 83 at about the listener's waist height, are each coupled to a hard drive playback (not shown) that has a separate output signal for each of the motion activated speakers associated with a respective one of the displays 81. When activated by the motion of an observer approaching a particular one of the displays 81, the appropriate individual output signal from the hard drive is applied to a specific, dedicated channel in a digital to analog converter, which in turn, couples the analog signal to the correct one of the motion activated speakers 84 .

Accordingly, as an observer approaches a painting of a bird in a particular one of the displays 81, the motion activated loudspeaker emits bird calls that are characteristic to the species in the painting. An additional feature of the invention provides for an array 79 of sound transducers 85, 88 and 94 on the wall 82 and respective, oppositely mounted sound transducers 86, 87 and 95 on the wall 83. The sound transducers 85, 80, 87 and 88 mounted on respective walls 82, 83 at 13′ above floor 93 are clearly above a listeners ear level. The below-ear level sound transducers 89, 90, 91, 92 are positioned on the associated walls 82, 83 at foot level, the junction between each of the walls and the floor 93.

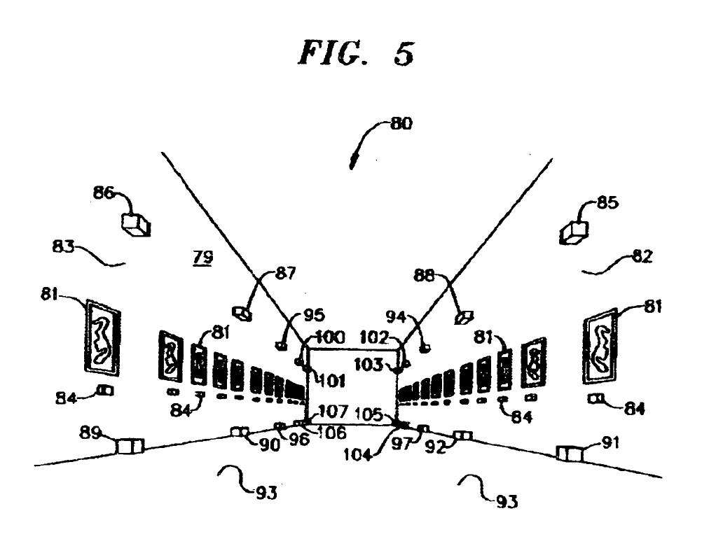

In operation, while the observer, listening to avian sounds from the activated speaker 84 that are specific to the particular display 81 that is under observation, the array 79 of the sound transducers 85 through 92 that form a parallelepiped encompassing several of the displays 81 on the walls 82, 83 are producing a different output signal, e.g. a flock of birds passing overhead. The configuration of the sound transducers 85 to 92 creates a definite aural sensation for the observer that the source of the sound, the flock of birds, is actually moving toward and then away from the observer while at the same time clearly hearing bird sounds unique to the species illustrated in the display 81 that is under observation. Note, with respect to FIG. 5, moreover, that the array of sound transducers 79 can be nested side-by-side with further additions of adjoining sets of above-ear level sound transducers 94, 102, 103; 95, 100, 101 and below-ear level sound transducers 97, 104, 105; 96, 106, 107. In this way, the illustrative phenomenon the sound of the flock of birds rushing over the observer's head can be continued through the length of the gallery.

The principles of the invention, moreover, are adaptable to much smaller configurations than those described above. For example, sound transducers should be mounted in an earphone, a first sound transducer positioned above the auditory canal; a second transducer positioned below the auditory canal; and a third sound transducer spaced from the first and second transducers, all within a single earphone and all communicating with the auditory canal. A second, similarly constructed earphone could be supplied to complete the usual pair of earphones so commonly used by binaural listeners.

What is claimed is:

1. Sound production apparatus for generating a full field sound and the perception of a moving source for a binaural listener comprising an array of sound transducers for providing a sound output spaced from each other, at least one of said sound transduce is being spaced above the listener's ears and at least one of said transducers being spaced below the listener's ears, and at least one further sound transducer having a sound output and being spaced from said above-ear level transducer and said below-ear level transducer, said sound transducer and said further sound transducer sound outputs intersecting in a volume to provide the full field sound and the moving sound source listener perception.

2. Sound production apparatus according to claim 1 further comprising at least two pairs of said sound transducers, said sound transducers being spaced from each other to form a parallelepiped, and one of said sound transducer pairs being spaced above the listener's ears and the other of said pairs being spaced below the listener's ears.

3. Sound production apparatus according to claim 2 wherein said sound transducers in said pairs establish sides to said parallelepiped, and said further sound transducer being positioned on one of said parallelepiped sides.

4. Sound production apparatus according to claim 3 wherein said further sound transducer is positioned in the center of said one of said parallelepiped sides.

5. Sound production apparatus according to claim 2 further comprising a second two pairs of sound transducers, said second two sound transducer pairs having one sound transducer pair above the listener's ear level each of said one sound transducers in said one pair being spaced from each other and spaced laterally from said one sound transducer pairs, said second pair of said sound transducer pairs having slid second sound transducer pair spaced below the listener's ear and, spaced from each other and spaced laterally from said other of said sound transducer pairs.

6. Sound production apparatus for generating a full field sound and the perception of a moving source of sound for a binaural listener comprising an array of eight sound transducers for generating sound, each of said eight transducers being spaced from each other to form a parallelepiped, four of said sound transducers being positioned above the listener's ear level and four of said sound transducers being positioned below the listener's ear level, said parallelepiped having sides formed thereby, at least a ninth sound transducer for generating sound being mounted at one of said parallelepiped sides oriented to project sound into said parallelepiped, and means for enabling sound generated by said eight sound transducers to intersect in a common volume within said parallelepiped with said ninth sound transducer sound orientation.

7. Sound production apparatus according to claim 6 further comprising at least another three sound transducers for generating sound, each of said another three sound transducers being mounted at separate parallelepiped sides to project sound into said parallelepiped and to intersect in said common volume within said parallelepiped.

8. Sound production apparatus according to claim 6 wherein said array further comprises a first plurality of cross beams, said cross beam ends being joined together to form first square surface, said four of said sound transducers positioned above the listener's ear level each being mounted at a respective corner of said square surface, a second plurality of cross beams joined as ends thereof to form a “U” shaped second square surface, two of said four sound transducers positioned below the listener's ear level being mounted in respective corners of said “U”, the other two of said four sound transducers positioned below the listener's ear level being mounted at the open ends of said “U”, support members bridging two parallel sides of said square surface for said sound transducers positioned above the listener's ear level for mounting said ninth sound transducer, a mounting support for said ninth sound transducer to project sound into said array, a plurality of perpendicular beams for joining said first and said second square surfaces parallel with and spacing said surfaces from each other, and brackets at said eight sound transducers to orient said eight sound transducers to project sound into said parallelepiped and to intersect at said common volume with said ninth sound transducer sound orientation.

9. A method for generating a full field sound and the perception of a moving source of the sound for a binaural listener comprising the steps of mounting a plurality of sound transducers for generating sound above the listener's ear level, mounting another plurality of sound transducers for generating sound below the listener's ear level, forming parallel surfaces among at least some of said sound transduce is in said respective two pluralities of mounted sound transducers, spacing said parallel surfaces from each other, orienting said sound from said above-ear level sound transducers and said below-ear level sound transducers into the volume between said parallel surfaces to enable said sound generated from said transducers to intersect therewithin and orienting another sound transducer sound output to further intersect with said two pluralities of sound transducer orientations.
